(19) United States
(12) Patent Application Publication
(10) Pub. No.: US 2016/0259422 A1
(43) Pub. Date: Sep. 8, 2016

(54) WEARABLE TERMINAL AND METHOD FOR CONTROLLING THE SAME

(71) Applicant: Panasonic Intellectual Property Corporation of America, Torrance, CA (US)

(72) Inventor: KAZUKI FUNASE, Osaka (JP)

(21) Appl. No.: 15/044,227

(22) Filed: Feb. 16, 2016

Related U.S. Application Data
(60) Provisional application No. 62/129,077, filed on Mar. 6, 2015.

(30) Foreign Application Priority Data
Jun. 30, 2015 (JP) 2015-131901

(51) Int. Cl. G06F 3/01; H04B 1/3827; H04B 1/3822; G06F 3/16; G06F 3/0484; G06F 3/0483; G06F 3/038; H04W 4/00; G06F 3/0346

(52) U.S. Cl. CPC G06F 3/017; H04W 4/005; H04B 1/385; H04B 1/3822; G06F 3/0346; G06F 3/04845; G06F 3/016; G06F 3/0483; G06F 3/0383; G06F 3/167

(57) ABSTRACT

A wearable terminal to be worn on an arm of a person includes a detection unit that detects a movement of the wearable terminal, a determination unit that determines whether the movement detected by the detection unit is a one of certain movements caused by certain actions of the person, a signal generation unit that, if the determination unit determines that the movement detected by the detection unit is one of the certain movements, generates a control signal for causing a navigation apparatus to change, in accordance with the detected certain movement, a map displayed on the navigation apparatus that is installed in a vehicle and that is capable of communicating with the wearable terminal, and a communication unit that transmits the control signal generated by the generation unit to the navigation apparatus.

### BACKGROUND

1. Technical Field

The present disclosure relates to a wearable terminal and a method for controlling the wearable terminal.

2. Description of the Related Art

An automobile navigation apparatus including a touch panel input display device displays, on a display screen, a current position or a route to a destination superimposed upon a map and obtains an operation performed by a user through the display screen.

A configuration that receives an operation input by a user through a touch sensor mounted on a steering column (steering post) has been disclosed (refer to Japanese Unexamined Patent Application Publication No. 2012-224170).

### SUMMARY

In one general aspect, the techniques disclosed here feature a wearable terminal worn on an arm of a person. The wearable terminal includes a detector that detects a movement of the wearable terminal, a determiner that determines whether the movement detected by the detector is a one of certain movements caused by certain actions of the person, a generator that, if the determiner determines that the movement detected by the detector is one of the certain movements, generates a control signal for causing a navigation apparatus to change, in accordance with the detected certain movement, a map displayed on the navigation apparatus, the navigation apparatus being installed in a vehicle and being capable of communicating with the wearable terminal, and a communicator that transmits the control signal generated by the generator to the navigation apparatus.

The wearable terminal in the present disclosure can help a user control a navigation apparatus without looking at a display screen.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a block diagram illustrating function blocks of a navigation system according to a first embodiment;

FIG. 1B illustrates an appearance of a wearable terminal according to the first embodiment worn by a user;

FIG. 1C is a schematic diagram illustrating a mode in which a vehicle and the navigation system according to the first embodiment are used;

FIG. 2A illustrates an appearance of a front of the wearable terminal according to the first embodiment;

FIG. 2B illustrates an appearance of a back of the wearable terminal according to the first embodiment;

FIG. 3 is a block diagram illustrating function blocks of the wearable terminal according to the first embodiment;

FIG. 4 is a block diagram illustrating function blocks of a navigation apparatus according to the first embodiment;

FIG. 5 is a sequence diagram illustrating a procedure of a process performed by the navigation system according to the first embodiment;

FIG. 6 is a flowchart illustrating a procedure of a process performed by the wearable terminal according to the first embodiment;

FIG. 7 is a schematic diagram illustrating a first movement of the wearable terminal according to the first embodiment;

FIG. 8 is a schematic diagram illustrating a direction detected by a detection unit during the first movement of the wearable terminal according to the first embodiment;

FIG. 9 is a schematic diagram illustrating details of the first movement of the wearable terminal according to the first embodiment;

FIG. 10 is a schematic diagram illustrating a second movement of the wearable terminal according to the first embodiment;

FIG. 11 is a schematic diagram illustrating a direction detected by the detection unit during the second movement of the wearable terminal according to the first embodiment;

FIG. 12 is a schematic diagram illustrating an example of acceleration detected by the detection unit and a first example of a determination method used by a determination unit according to the first embodiment;

FIG. 13 is a schematic diagram illustrating an example of the acceleration detected by the detection unit and a second example of the determination method used by the determination unit according to the first embodiment;

FIG. 14 is a schematic diagram illustrating a first modification of the first movement of the wearable terminal according to the first embodiment;

FIG. 15 is a schematic diagram illustrating a second modification of the first movement of the wearable terminal according to the first embodiment;

FIG. 16 is a diagram illustrating control signals generated by a signal generation unit according to the first embodiment;

FIG. 17 is a diagram illustrating types of display control performed on the navigation apparatus according to the first embodiment;

FIG. 18 is a diagram illustrating types of control performed on the navigation apparatus according to the first embodiment;

FIG. 19 is a diagram illustrating a display unit of the navigation apparatus according to the first embodiment;

FIG. 20 is a block diagram illustrating function blocks of a wearable terminal according to a second embodiment;

FIG. 21 is a block diagram illustrating function blocks of a navigation apparatus according to the second embodiment;

FIG. 22 is a sequence diagram illustrating a procedure of a process performed by a navigation system according to the second embodiment; and

FIG. 23 is a block diagram illustrating function blocks of a navigation system according to a modification of the embodiments.

### DETAILED DESCRIPTION

### Underlying Knowledge Forming Basis of the Present Disclosure

The present inventors have found that the following problem arises in the navigation apparatus described in the “BACKGROUND”.

Navigation apparatuses for vehicles (e.g., automobiles) including touch panel input display devices as display screens are widely used. Such kind of navigation apparatus obtains positional information using a Global Positioning System (GPS) or the like. The navigation system then displays, on a display screen, a current position or a route to a destination superimposed upon a map and obtains a touch (includes tap, swipe, and the like) operation performed by a user on the display screen.

The navigation apparatus is desirably operable during driving, but if the user looks at the display screen of the navigation apparatus too long, the user might fail to drive the automobile safely. A method for receiving an operation performed by the user during driving that takes into consideration safety, therefore, needs to be examined.

As described above, if the user performs an operation on a navigation apparatus or the like using a touch panel, the user needs to determine a position at which the user touches the display screen while looking at an image displayed on the display screen. In this case, the user looks away from a driving direction (forward direction) for a long time, and the user can fail to drive the automobile safely. In the case of a touch panel device, a function of displaying information and a function of receiving an operation performed by the user are realized on the same screen. A period of time for which the user looks at the screen, therefore, becomes longer than in the case of an input/display device in which a display unit and an input operation unit are separately provided. If the user needs to touch an input portion, which includes virtual buttons, provided on the screen, the user needs to look at and concentrate on a touch area in which the input portion is provided. The safety of driving thus decreases especially when the user looks at the input portion.

During these years, users are increasingly using applications (so-called automotive navigation applications), not dedicated terminals of navigation apparatuses, installed on devices (e.g., smartphones) including touch panels. Because display areas of input/display devices in which display units and input operation units are separately provided (e.g., feature phones including button input units) are small relative to the entirety of the devices, such input/display devices are not popular among those who give priority to design and visibility. A touch panel method, therefore, is often adopted as a method for receiving operations for automotive navigation systems, and even if physical input units (buttons) are provided, such input units tend to be small. The user therefore needs to look at the input unit during driving in order to control the navigation apparatus, which decreases the safety of driving.

On the other hand, as in Japanese Unexamined Patent Application Publication No. 2012-224170, an input unit can be independently provided by providing a sensor or physical buttons on a steering column of an automobile. A user who desires to use this system, however, needs to purchase a new automobile including a steering column (steering wheel) equipped with the technique disclosed in Japanese Unexamined Patent Application Publication No. 2012-224170 or replace a whole steering system of his/her automobile, which might not be realistic for the user.

The present disclosure provides a wearable terminal or the like that helps the user control a navigation apparatus without looking at a display screen.

In order to solve such a problem, a wearable terminal according to an aspect of the present disclosure is a wearable terminal worn on an arm of a person. The wearable terminal includes a detector that detects a movement of the wearable terminal, a determiner that determines whether the movement detected by the detector is a one of certain movements caused by certain actions of the person, a generator that, if the determiner determines that the movement detected by the detector is one of the certain movements, generates a control signal for causing a navigation apparatus to change, in accordance with the detected certain movement, a map displayed on the navigation apparatus, the navigation apparatus being installed in a vehicle and being capable of communicating with the wearable terminal, and a communicator that transmits the control signal generated by the generator to the navigation apparatus.

As a result, the wearable terminal can help the user control the navigation apparatus without looking at the display screen.

As described above, since a navigation apparatus according to an example of the related art includes a display unit and an input portion in the same visual area, for example, the user needs to look at a display screen even during driving in order to control an automotive navigation system. The user therefore looks away from the forward direction for a long time. Especially when a smartphone or the like is used as a navigation system, an input portion to be touched becomes smaller as a screen becomes smaller. In this case, the user needs to look at and concentrate on the screen for an even longer time. The user might therefore fail to drive the automobile safely.

On the other hand, in the case of the wearable terminal according to the aspect of the present disclosure, the display screen of the navigation apparatus is controlled if one of the certain rotational movements of the wearable terminal worn on the arm is detected. That is, the user can control the display screen of the navigation system through a simple operation for which the user need not move eyes or to which the user need not pay attention, such as a twist of the arm. The user therefore need not look at or concentrate on an input portion of the display screen of the navigation apparatus. Since the user can easily enlarge or reduce map information that can be operated during driving using the wearable terminal according to the aspect of the present disclosure, the display screen of the navigation system can be controlled more safely.

In addition, the user can solve the above problem at low cost only by purchasing the wearable terminal according to the aspect of the present disclosure, and the user need not replace a whole steering system of the automobile unlike in Japanese Unexamined Patent Application Publication No. 2012-224170.

For example, the certain movements may be rotational movements of the wearable terminal caused by certain actions of the person.

In this case, the wearable terminal can distinguish operations for controlling the navigation apparatus from other operations (steering wheel operations, changing of gears, checking of the time, and the like) performed by the user during driving more clearly, thereby reducing the possibility of erroneous detection.

For example, the wearable terminal may have a ring shape when wound around the arm of the person. The certain movements may be rotational movements around the arm in a circumferential direction of the wearable terminal caused when the person twists the arm on which the wearable terminal is worn.

In this case, since the wearable terminal associates a rotational movement, such as a twist of the arm or a wrist of the user, with an operation for enlarging or reducing the map, a user interface can be provided that a user who uses the wearable terminal for the first time or a user who is not accustomed to performing operations can easily understand.

For example, the control signal may be a control signal for causing the navigation apparatus to enlarge or reduce the map in accordance with the detected certain movement.

In this case, the wearable terminal can specifically change the map by enlarging or reducing the map displayed on the navigation apparatus in accordance with an operation performed by the user.

For example, the determiner may determine whether the movement detected by the detector is (a) a first movement, which is one of the certain movements and a first rotational movement, or (b) a second movement, which is one of the certain movements and a second rotational movement in a direction opposite to the direction of the first rotational movement. (i) If the determiner determines that the movement detected by the detector is the first movement, the generator may generate the control signal for causing the navigation apparatus to enlarge the map, and (ii) if the determiner determines that the movement detected by the detector is the second movement, the generator may generate the control signal for causing the navigation apparatus to reduce the map.

In this case, the user can enlarge or reduce the map through an easier operation using the wearable terminal. Because the user can enlarge the map by twisting the arm to the right and reduce the map by twisting the arm to the left, for example, the user can intuitively understand the operations. A user interface that can be easily operated can thus be provided.

For example, even if the detector detects a new movement of the wearable terminal within a certain period of time after the determiner determines the movement detected by the detector is one of the certain movements, the determiner does not determine whether the new movement is one of the certain movements.

In this case, it is possible to prevent the wearable terminal from erroneously detecting an operation performed by the user. After twisting the arm or a wrist in a direction (e.g., to the right), the user usually returns the arm to its original attitude (to the left) (also referred to as a “returning action”). If, therefore, the user twists the arm to enlarge the map, for example, the map might be reduced as a result of erroneous detection of a subsequent returning motion. The wearable terminal can prevent such erroneous detection.

For example, the determiner may determine whether the movement detected by the detector is (a) a third movement, which is one of the certain movements caused when a rotational movement occurs in a first direction and then another rotational movement occurs in a second direction, which is opposite to the first direction, or (b) a fourth movement, which is one of the certain movements caused when a rotational movement occurs in the second direction and then another rotational movement occurs in the first direction. (i) If the determiner determines that the movement detected by the detector is the third movement, the generator may generate the control signal for causing the navigation apparatus to enlarge the map, and (ii) if the determiner determines that the movement detected by the detector is the fourth movement, the generator may generate the control signal for causing the navigation apparatus to reduce the map.

In this case, it is possible to prevent the wearable terminal from erroneously detecting an operation performed by the user. After releasing his/her hand from the steering wheel and twisting the arm, the user usually returns the arm to its original attitude before grasping the steering wheel again. Since the wearable terminal determines a combination of a twist of the arm and another twist of the arm in an opposite direction as a single operation, erroneous detection can be prevented.

For example, the certain movements may changes in a position and an attitude of the wearable terminal caused at an acceleration equal to or higher than a threshold.

In this case, the wearable terminal can clearly distinguish operations for controlling the navigation apparatus from other operations performed by the user during driving on the basis of the acceleration of operations.

For example, the wearable terminal may further include a display that, if the determiner determines that the movement detected by the detector is one of the certain movements, displays an image indicating occurrence of the detected certain movement.

In this case, if an operation for controlling the navigation apparatus is detected, the wearable terminal notifies the user of the detection of the operation by displaying an image. If the user is not notified of the detection of the operation, the user might repeat the operation, but since the image is displayed in this case, it is possible to prevent the user from repeating the operation.

For example, the wearable terminal may further include a vibrator that vibrates if the determiner determines that the movement detected by the detector is one of the certain movements.

In this case, if an operation for controlling the navigation apparatus is detected, the wearable terminal notifies the user of the detection of the operation through vibration. As a result, as in the above case, it is possible to prevent the user from repeating the operation.

For example, the wearable terminal may further include a light emitter that emits light if the determiner determines that the movement detected by the detector is one of the certain movements.

In this case, if an operation for controlling the navigation apparatus is detected, the wearable terminal notifies the user of the detection of the operation by emitting light. As a result, as in the above case, it is possible to prevent the user from repeating the operation.

For example, if the determiner determines that the movement detected by the detector is one of the certain movements, the generator may generate a control signal for causing the navigation apparatus to display an image indicating occurrence of the detected certain movement on a display screen of the navigation apparatus. The communicator may transmit the control signal generated by the generator to the navigation apparatus.

In this case, if an operation for controlling the navigation apparatus is detected, the wearable terminal notifies the user of the detection of the operation and a change made to an image displayed on the navigation apparatus in accordance with the operation by displaying an image in an easy-to-understand manner. As a result, as in the above case, it is possible to prevent the user from repeating the operation.

For example, if the determiner determines that the movement detected by the detector is one of the certain movements, the generator may generate a control signal for causing the navigation apparatus to output a sound indicating occurrence of the detected certain movement. The communicator may transmit the control signal generated by the generator to the navigation apparatus.

In this case, if an operation for controlling the navigation apparatus is detected, the wearable terminal notifies the user of the detection of the operation and a change made to an image displayed on the navigation apparatus in accordance with the operation by outputting a sound. As a result, as in the above case, it is possible to prevent the user from repeating the operation.

For example, the communicator may be capable of communicating with the navigation apparatus through wireless communication of a connection type according to a certain wireless communication standard. If the navigation apparatus is located in a range in which the communicator is capable of communicating with the navigation apparatus, the communicator may automatically, or in accordance with an instruction from the person, establish a wireless communication connection with the navigation apparatus. The determiner may make a determination only when the connection is established.

In this case, the wearable terminal makes a determination as to an operation for controlling the navigation apparatus only when the communication connection with the navigation apparatus is established. When the communication connection is not established, control information is not transmitted to the navigation apparatus even if the operation performed by the user is detected. By not making a determination in this state, a processing load and power consumption can be reduced.

For example, the determiner may make a determination when the communicator has established the connection and received, from the navigation apparatus, a first notification, which indicates that the navigation apparatus is in a first reception state, in which the navigation apparatus is capable of receiving an operation for enlarging or reducing the map.

In this case, the wearable terminal can make a determination on the basis of a notification from the navigation apparatus only when the communication connection with the navigation apparatus is established and the navigation apparatus is in the first reception state. The wearable terminal makes a determination only when, for example, the communication connection between the wearable terminal and the navigation apparatus is established and the navigation apparatus is performing navigation. As a result, it is possible to prevent the wearable terminal from making a determination when the navigation apparatus is used but the map need not be enlarged or reduced.

For example, the determiner does not make a determination when the communicator has established the connection and received, from the navigation apparatus, a second notification, which indicates that the navigation apparatus has stopped receiving an operation for enlarging or reducing the map.

In this case, it is possible to prevent the wearable terminal from making a determination when the map need not be enlarged or reduced.

For example, when the navigation apparatus is in the first reception state, the generator may generate a control signal for displaying, on a display screen of the navigation apparatus, a first guidance image for notifying the person of the operation for enlarging or reducing the map. The communicator may transmit the control signal generated by the generator to the navigation apparatus.

In this case, the wearable terminal can notify, through the navigation apparatus, the user that the navigation apparatus can be controlled by moving the wearable terminal. The user can understand, for example, that the user can enlarge or reduce the map by twisting the arm when a certain image is displayed on the navigation apparatus. That is, the user can understand whether the wearable terminal can currently receive a certain rotational movement for controlling the display screen of the navigation apparatus.

For example, the first guidance image may include an image indicating a mode of a rotational movement of the wearable terminal and an image indicating how the map changes as a result of the rotational movement of the wearable terminal.

In this case, the user can specifically understand what kind of action enlarges or reduces the map. The user can control the navigation apparatus using the wearable terminal without reading an instruction manual of the wearable terminal or the like in advance.

For example, the determiner may make a determination when the communicator has received, from the navigation apparatus, a third notification, which indicates that the navigation apparatus is not in the first reception state but in a second reception state, in which the wearable terminal receives operations performed by the person other than the operation for enlarging or reducing the map.

In this case, the wearable terminal can help the user control the navigation apparatus without looking at the display screen with respect to operations other than the operation for enlarging or reducing the map.

For example, the operations performed by the person other than the operation for enlarging or reducing the map may include (i) an operation for displaying a display area that is currently not displayed on the map, (ii) an operation for switching information superimposed upon the map, and (iii) an operation for turning to a next page or turning back to a previous page of information that is different from the map and that includes a plurality of pages.

In this case, the wearable terminal can specifically perform operations other than the operation for enlarging or reducing map information. In addition, by changing a type of control performed on the navigation apparatus depending on a timing at which a certain rotational movement made by the user is received, various types of display control can be realized even if the number of operation patterns (e.g., a twist in a direction and a twist in an opposite direction) is small.

For example, when the navigation apparatus is in the second reception state, the generator may generate a control signal for displaying, on a display screen of the navigation apparatus, a second guidance image for notifying the person of operations performed on the navigation apparatus other than the operation for enlarging or reducing the map. The communicator may transmit the control signal generated by the generator to the navigation apparatus.

In this case, the wearable terminal can notify, through the navigation apparatus, the user that the user can control the navigation apparatus by moving the wearable terminal. The user can understand, for example, that the user can control the navigation apparatus by twisting the arm when a certain image is displayed on the navigation apparatus.

For example, the second guidance image may include an image indicating a mode of a rotational movement of the wearable terminal and an image indicating a result of an operation performed as a result of the rotational movement of the wearable terminal.

In this case, the user can specifically and intuitively understand what kind of action controls the display screen of the navigation apparatus in what way.

For example, the vehicle may be an automobile. The communicator may receive control information regarding control of the automobile through the navigation apparatus. The control information regarding the control of the automobile may include information indicating whether an acceleration operation or a braking operation has been performed in the automobile. Only if the control information received by the communicator indicates that either the acceleration operation or the braking operation has been performed, (i) the determiner may make a determination or (ii) the communicator may transmit a control signal.

In this case, the wearable terminal can cooperate with a control system of the automobile and receive a certain rotational movement for controlling the navigation apparatus only during driving. When the automobile is stationary, for example, risk is relatively small even if the user inputs an operation using a touch panel. On the other hand, when the automobile is stationary, for example, an erroneous operation might occur, and the wearable terminal desirably does not receive a certain rotational movement for controlling the navigation apparatus. By performing control in the above-described manner, the wearable terminal receives an operation only during driving and does not receive an operation when the automobile is stationary.

For example, the vehicle may be an automobile. The communicator may receive control information regarding control of the automobile through the navigation apparatus. The control information regarding the control of the automobile may include information indicating whether a steering wheel of the automobile has been operated. If the control information received by the communicator indicates that the steering wheel has been operated, (i) the determiner may be inhibited from making a determination or (ii) the communicator may be inhibited from transmitting a control signal.

In this case, the wearable terminal can cooperate with the control system of the automobile and does not receive a certain rotational movement for controlling the navigation apparatus while the user is operating the steering wheel. While the user is operating the steering wheel, the wearable terminal might determine that one of the certain rotational movements has occurred, and it might be difficult to distinguish the steering wheel operation from an operation for controlling the navigation apparatus. By performing control in the above-described manner, it is possible to suppress erroneous detection of the steering wheel operation as an operation for controlling the navigation apparatus.

The wearable terminal may cooperate with the control system of the automobile and perform various other types of control through the certain rotational movements. The wearable terminal may cooperate with the control system of the automobile, for example, if (i) an engine of the automobile has not started and/or (ii) no person is inside the automobile. If one of the certain rotational movements occurs in this case, doors of the automobile may be unlocked. As a result, the doors can be unlocked more easily and safely than in a common method for unlocking doors of an automobile using a key. Although there is a method for unlocking doors of an automobile without using a key, that is, through fingerprint recognition or the like, the user needs to take off gloves in the winter or in other scenes before unlocking the doors of the automobile if the user wears the gloves. The above method is therefore more convenient. In addition, by setting conditions such as (i) and (ii) mentioned above, an erroneous operation such as unlocking of the doors during driving can be prevented. It is assumed here that the control system of the automobile has obtained information regarding the conditions (i) and (ii) using a certain method.

For example, the certain wireless communication standard may be Bluetooth (registered trademark) or Institute of Electrical and Electronics Engineers (IEEE) 802.11.

In this case, the wearable terminal can specifically communicate with the navigation apparatus in accordance with Bluetooth (registered trademark) or IEEE 802.11.

For example, at least any of the determiner, the generator, and the communicator may include a processor.

In addition, a method for controlling a wearable terminal according to another aspect of the present disclosure is a method for controlling a wearable terminal to be worn on an arm of a person. The method includes detecting a movement of the wearable terminal, determining whether the movement detected in the detecting is a one of certain movements caused by certain actions of the person, generating, if it is determined in the determining that the movement detected in the detecting is one of the certain movements, a control signal for causing a navigation apparatus to change, in accordance with the detected certain movement, a map displayed on the navigation apparatus, the navigation apparatus being installed in a vehicle and being capable of communicating with the wearable terminal, and transmitting the control signal generated in the generating to the navigation apparatus.

As a result, the same advantageous effects as those of the wearable terminal can be produced.

For example, at least any of the determining, the generating, and the transmitting may be performed by a processor.

It should be noted that these general or specific aspects may be implemented as a system, a method, an integrated circuit, a computer program, a recording medium such as a computer-readable compact disc read-only memory (CD-ROM), or any selective combination thereof.

Embodiments will be specifically described hereinafter with reference to the drawings.

The embodiments that will be described hereinafter indicate general or specific examples. Values, shapes, material, components, positions at which the components are arranged, modes in which the components are connected, steps, order of steps, and the like that will be described in the following embodiments are examples, and do not limit the present disclosure. In addition, among the components described in the following description, components that are not described in the independent claims, which define broadest concepts, are described as arbitrary components. Processes and configurations described in the plurality of embodiments that will be described hereinafter may be combined with each other in any way.

### First Embodiment

In a first embodiment, a wearable terminal that helps a user control a navigation apparatus without looking at a display screen will be described.

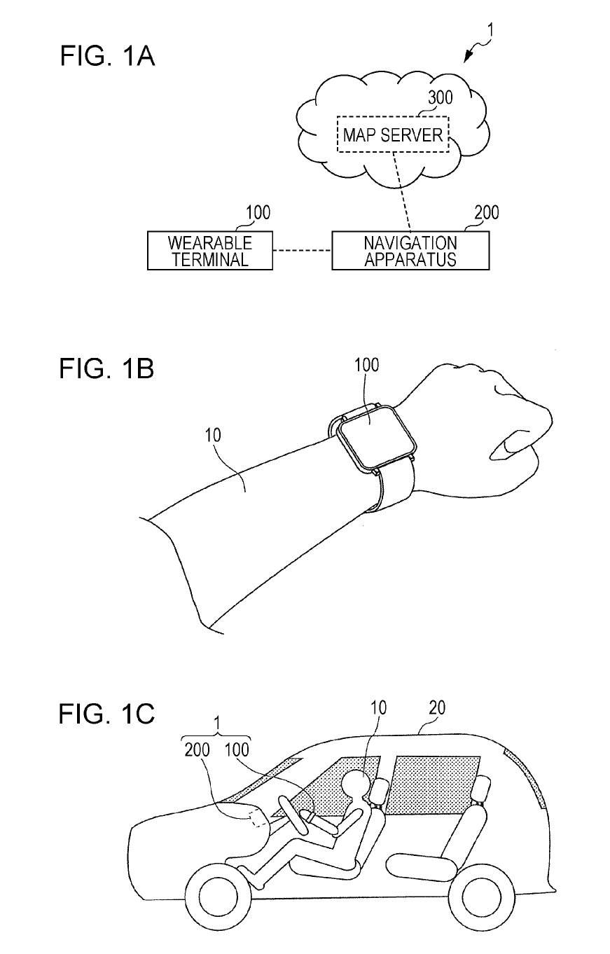

FIG. 1A is a block diagram illustrating function blocks of a navigation system 1 according to the present embodiment. FIG. 1B illustrates an appearance of a wearable terminal 100 according to the present embodiment worn by a user 10. FIG. 1C is a schematic diagram illustrating a mode in which a vehicle 20 and the navigation system 1 according to the present embodiment are used.

As illustrated in FIG. 1A, the navigation system 1 includes the wearable terminal 100 and a navigation apparatus 200. The navigation system 1 may further include a map server 300.

The wearable terminal 100 is a terminal attached to a part of a body of the user 10 of the navigation system 1. When the wearable terminal 100 is worn by the user 10, a position and an attitude of the wearable terminal 100 change as a position and an attitude of the part of the user's body on which the wearable terminal 100 is worn change. As illustrated in FIG. 1B, for example, the wearable terminal 100 is a wristwatch terminal or a wristband terminal wound around an arm of the user 10, which is a part of the user's body.

The navigation apparatus 200 is a navigation apparatus that is installed in the vehicle 20 (e.g., an automobile) and that provides various pieces of information for the user 10 of the vehicle 20. The navigation apparatus 200 displays, on a screen, a map indicating surroundings of a current position of the navigation apparatus 200, that is, the vehicle 20, and the current position of the vehicle 20 on the map, for example, to show the current position of the vehicle 20 to the user 10. The navigation apparatus 200 also receives an operation performed by the user 10 thereon through a touch panel or the like. If the navigation apparatus 200 has a function of playing back music, the navigation apparatus 200 lets the user 10 select a song to be played back. The vehicle 20 may be an automobile.

As illustrated in FIG. 1C, the navigation apparatus 200 may be embedded in a dashboard of the automobile as the vehicle 20, or may be installed in the vehicle 20 in a way that the navigation apparatus 200 can be easily removed and used outside the vehicle 20.

Map information or the like may be stored in the navigation apparatus 200 in advance, or the navigation apparatus 200 may realize the above function in cooperation with an external map server with which the navigation apparatus 200 can communicate through a network. Alternatively, the navigation apparatus 200 need not be a dedicated terminal but may be a device (e.g., a smartphone) that includes a touch panel and on which a dedicated application is installed. A display on which the navigation apparatus 200 displays various pieces of information may be a touch panel display or a head-up display.

The map server 300 is a server apparatus storing map information. The map server 300 is connected to the navigation apparatus 200 through a communication network. After obtaining information indicating a position from the navigation apparatus 200, the map server 300 provides map information including the obtained position for the navigation apparatus 200. The communication network is realized by a mobile phone line, a satellite communication line, a data communication line, a network obtained by combining these lines, or the like.

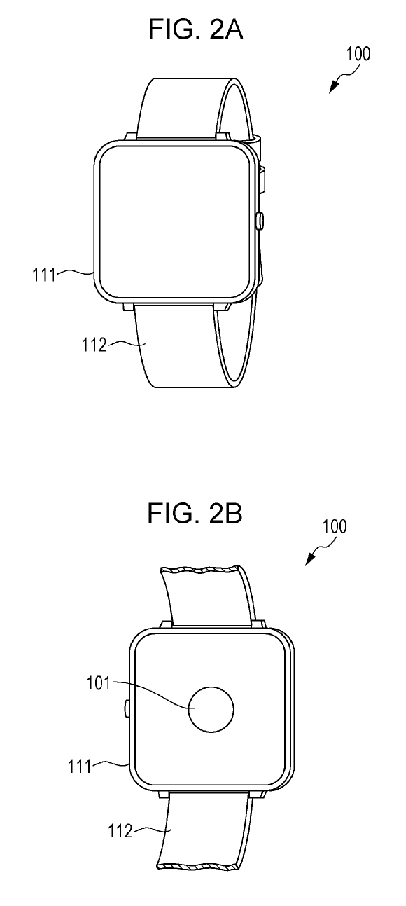

FIG. 2A illustrates an appearance of a front of the wearable terminal 100 according to the present embodiment. FIG. 2B illustrates an appearance of a back of the wearable terminal 100 according to the present embodiment.

As illustrated in FIGS. 2A and 2B, the wearable terminal 100 includes a body 111 and a band 112. The body 111 is a part on which numbers or hands indicating time are displayed and includes a device that obtains and processes various pieces of information and other components. The band 112 is connected to the body 111 and wound around part of an arm of the user 10. When worn by the user 10, the wearable terminal 100 has a ring shape and is wound around part of an arm of the user 10.

The above description of the body 111 and the band 112 is an example, and the band 112 may have part or the entirety of the function of the body 111 in the above description. In addition, the body 111 and the band 112 need not be visually distinguished from each other. If the wearable terminal 100 is a wristband terminal, the wearable terminal 100 may seemingly include only the band 112.

A detector 101 is provided on a back surface of the wearable terminal 100. Details of a function of the device management unit 101 will be described later. The device management unit 101 may be provided inside the body 111 or on the band 112 instead of the back of the body 111. Another component that will be described later may also be provided on the back of the body 111.

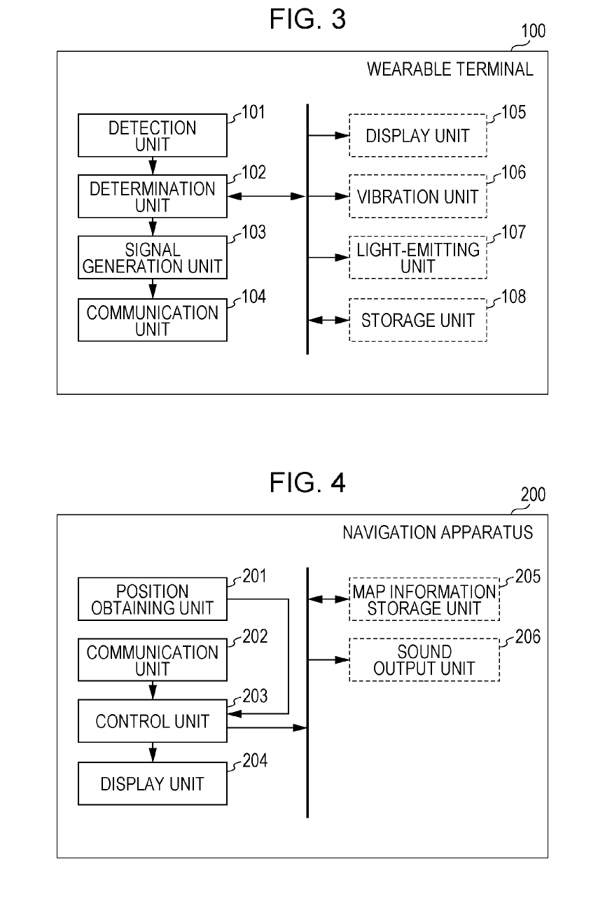

FIG. 3 is a block diagram illustrating function blocks of the wearable terminal 100 according to the present embodiment.

As illustrated in FIG. 3, the wearable terminal 100 includes a detection unit 101, a determination unit 102, a signal generation unit 103, and a communication unit 104. The wearable terminal 100 may further include a display unit 105, a vibration unit 106, a light-emitting unit 107, and a storage unit 108.

The detection unit 101 is a device or a processing unit that detects various pieces of information relating to the wearable terminal 100. More specifically, the detection unit 101 includes an acceleration sensor and a gyro sensor and detects the acceleration and angular velocity of the wearable terminal 100. The detection unit 101 detects the movement of the wearable terminal 100 using the sensors and detects changes in the position and attitude of the wearable terminal 100, that is, more specifically, the amount of change in position and attitude of the wearable terminal 100, on the basis of the detected movement. If the wearable terminal 100 is not moving, the detection unit 101 detects that there is no change in position or attitude, that is, more specifically, that the amount of change is zero. The detection unit 101 provides information regarding the detected movement for the determination unit 102.

The detection unit 101 may also detect biological information including a heart rate and body temperature of the user 10 wearing the wearable terminal 100. If the detection unit 101 obtains the heart rate or the body temperature of the user 10, the user 10 may be identified from the information and results of certain movements may be changed to ones registered for the identified user 10.

At this time, if the user 10 is subjected to person authentication through detection of biological information but the authentication fails, control (includes some or all of types of control described herein) performed after certain movements are detected may be invalidated.

The determination unit 102 is a processing unit that determines whether a movement detected by the detection unit 101 is one of the certain movements caused by certain actions of the user 10. More specifically, the certain movements refer to rotational movements of the wearable terminal 100 caused by the certain actions of the user 10. More specifically, the certain movements refer to rotational movements around an arm, as an axis (rotation axis), of the user on which the wearable terminal 100 is worn caused when the user 10 twists the arm, that is, rotational movements in a circumferential direction of the band 112. The rotational movements will be described in detail later.

The certain movements may be different or common between users. If the certain movements are different between users, the determination unit 102 makes a determination using movements registered for a user identified using information regarding a heart rate or the like detected by the detection unit 101.

The signal generation unit 103, which corresponds to a generator, is a processing unit that generates a control signal for controlling the navigation apparatus 200. More specifically, if the determination unit 102 determines that a movement detected by the detection unit 101 is one of the certain movements, the signal generation unit 103 generates a control signal for causing the navigation apparatus 200 to change a map displayed on the navigation apparatus 200 in accordance with the certain movement. The control signal is, for example, a control signal for causing the navigation apparatus 200 to enlarge or reduce the map displayed on the navigation apparatus 200. The signal generation unit 103 transmits the generated signal to the navigation apparatus 200 through the communication unit 104.

If the determination unit 102 determines that a movement detected by the detection unit 101 is one of the certain movements, the signal generation unit 103 may generate a control signal for causing the navigation apparatus 200 to display an image indicating occurrence of the certain movement on the display screen of the navigation apparatus 200.

Alternatively, if the determination unit 102 determines that a movement detected by the detection unit 101 is one of the certain movements, the signal generation unit 103 may generate a control signal for causing the navigation apparatus 200 to output a sound indicating occurrence of the certain movement.

When the navigation apparatus 200 is in a first reception state (a state in which the navigation apparatus 200 can receive an operation for enlarging or reducing the displayed map), the signal generation unit 103 may generate a control signal for causing the navigation apparatus 200 to display, on the display screen of the navigation apparatus 200, an image (corresponds to a first guidance image) for notifying the user 10 of an operation for enlarging or reducing the map. The first guidance image may be an image including an image indicating rotational movements of the wearable terminal 100 and an image indicating changes to the map caused by the rotational movements of the wearable terminal 100.

When the navigation apparatus 200 is in a second reception state (a state that is different from the first reception state and in which the navigation apparatus 200 receives operations performed by the user 10 other than the operation for enlarging or reducing the map), the signal generation unit 103 may generate a control signal for displaying, on the display screen of the navigation apparatus 200, an image (corresponds to a second guidance image) for notifying the user 10 of operations that can be performed on the navigation apparatus 200 other than the operation for enlarging or reducing the map. The second guidance image may be an image including an image indicating rotational movements of the wearable terminal 100 and an image indicating results of the rotational movements of the wearable terminal 100.

The communication unit 104 is a communication interface for communicating with the navigation apparatus 200. More specifically, the communication unit 104 can communicate with the navigation apparatus 200 through wireless communication of a connection type according to a certain wireless communication standard. If the navigation apparatus 200 is located in a range in which the communication unit 104 can communicate with the navigation apparatus 200, the communication unit 104 automatically, or in accordance with an instruction from the user 10, establishes a communication connection (hereinafter simply referred to as a “connection”) for wireless communication with the navigation apparatus 200. The communication unit 104 transmits a control signal generated by the signal generation unit 103 to the navigation apparatus 200 through the established connection. The certain wireless communication standard is, for example, Bluetooth (registered trademark) or IEEE 802.11. In the case of Bluetooth (registered trademark), the establishment of the connection corresponds to establishment of a pairing, and in the case of IEEE 802.11, the establishment of the connection corresponds to establishment of a communication link.

The display unit 105 is a display screen on which an image of numbers or hands indicating time is displayed. The display unit 105 basically displays the image, but also displays letters or an image of information other than the numbers or the hands indicating time (e.g., an outgoing or incoming electronic mail, weather, temperature, a heart rate, or a photograph) on the basis of an operation performed by the user 10 or when a certain condition is satisfied. In a specific example, if the determination unit 102 determines that a movement detected by the detection unit 101 is one of the certain movements, the display unit 105 displays an image indicating occurrence of the certain movement.

The vibration unit 106 sends notifications to the user 10 through vibration. The vibration unit 106 vibrates when a certain condition is satisfied. In a specific example, the vibration unit 106 vibrates if the determination unit 102 determines that a movement detected by the detection unit 101 is one of the certain movements. The vibration unit 106 is realized by, for example, a vibration motor.

The light-emitting unit 107 sends notifications to the user 10 by emitting light. The light-emitting unit 107 emits light when a certain condition is satisfied. In a specific example, the light-emitting unit 107 emits light if the determination unit 102 determines that a movement detected by the detection unit 101 is one of the certain movements. The light-emitting unit 107 is realized by, for example, a light-emitting diode (LED).

The storage unit 108 is a storage device used for storing various pieces of information. In the storage unit 108, for example, image data regarding images displayed on the display unit 105, vibration patterns of the vibration unit 106, light-emitting patterns of the light-emitting unit 107, and the like are stored. Each of the above pieces of information may be different between users who wear the wearable terminal 100. The storage unit 108 is realized by a nonvolatile storage device such as a flash memory, a hard disk drive (HDD), or a solid-state drive (SSD).

The determination unit 102 may make a determination only when the communication unit 104 has established the connection.

The determination unit 102 may determine whether to make a determination on the basis of various notifications (described later) transmitted from the navigation apparatus 200 to the wearable terminal 100.

More specifically, the determination unit 102 may make a determination when, for example, the communication unit 104 has established the connection and the wearable terminal 100 (e.g., the communication unit 104) has received a first notification, which indicates that the navigation apparatus 200 is in the first reception state, from the navigation apparatus 200.

Even when the communication unit 104 has established the connection, the determination unit 102 need not make a determination if the wearable terminal 100 (e.g., the communication unit 104) receives a second notification, which indicates that the navigation apparatus 200 has stopped receiving the operation for enlarging or reducing the map (that is, indicates that the first reception state has ended), from the navigation apparatus 200.

The determination unit 102 may make a determination if the wearable terminal 100 (e.g., the communication unit 104) receives a third notification, which indicates that the navigation apparatus 200 is not in the first reception state but in the second reception state, in which the wearable terminal 100 receives the operations performed by the user 10 other than the operation for enlarging or reducing the map, from the navigation apparatus 200.

The operations performed by the user 10 other than the operation for enlarging or reducing the map may include, for example, (i) an operation for displaying a display area that is currently not displayed on the map, (ii) an operation for switching information superimposed upon the map, and (iii) an operation for turning to a next page or turning back to a previous page of information that is different from the map and that includes a plurality of pages.

If the navigation apparatus 200 includes an obtaining unit (not illustrated) that obtains control information regarding control of the automobile as the vehicle 20, the following operation may be performed. That is, the obtaining unit of the navigation apparatus 200 obtains the control information. The control information includes, for example, information indicating whether an acceleration operation or a braking operation has been performed in the automobile.

The communication unit 104 receives the control information through the navigation apparatus 200. Only if the control information received by the communication unit 104 indicates that either an acceleration operation or a braking operation has been performed, (i) the determination unit 102 may make a determination or (ii) the communication unit 104 may transmit a control signal. By cooperating with a control system of the automobile in this manner, operations can be received only while the automobile is running and operations are not received when the automobile is stationary.

If the navigation apparatus 200 includes the obtaining unit (not illustrated) that obtains control information regarding the control of the automobile as the vehicle 20, the following operation may be performed. That is, the obtaining unit of the navigation apparatus 200 obtains the control information. The control information includes, for example, information indicating whether a steering wheel of the automobile has been operated. The communication unit 104 receives the control information through the navigation apparatus 200. If the control information received by the communication unit 104 indicates that the steering wheel has been operated, (i) the determination unit 102 may be inhibited from making a determination or (ii) the communication unit 104 may be inhibited from transmitting a control signal. By cooperating with the control system of the automobile, an operation performed on the steering wheel is not erroneously detected as an operation for controlling the navigation apparatus 200.

FIG. 4 is a block diagram illustrating function blocks of the navigation apparatus 200 according to the present embodiment.

As illustrated in FIG. 4, the navigation apparatus 200 includes a position obtaining unit 201, a communication unit 202, a control unit 203, and a display unit 204. The navigation apparatus 200 may further include a map information storage unit 205 and a sound output unit 206.

The position obtaining unit 201 is a device or a processing unit that obtains positional information indicating the current position of the vehicle 20. The position obtaining unit 201 provides the obtained positional information for the control unit 203. The position obtaining unit 201 obtains positional information using, for example, the GPS.

The communication unit 202 is a communication interface that obtains control information transmitted from the wearable terminal 100. The communication unit 202 provides the obtained control information for the control unit 203.

The communication unit 202 may communicate with the map server 300. The communication unit 202 obtains positional information from the position obtaining unit 201 through the control unit 203 and transmits the obtained positional information to the map server 300. The communication unit 202 receives a map including the current position transmitted from the map server 300 in accordance with the transmitted positional information. After receiving map information, the communication unit 202 stores the received map information in the map information storage unit 205.

The control unit 203 is a processing unit that controls the operation of the navigation apparatus 200. More specifically, the control unit 203 obtains control information generated by the signal generation unit 103 of the wearable terminal 100 through the communication unit 202 and performs control by changing an image displayed on the display unit 204 in accordance with the obtained control information. The control unit 203 obtains positional information indicating the current position of the vehicle 20 from the position obtaining unit 201 and changes the map displayed on the display unit 204.

The control unit 203 may transmit various notifications to the wearable terminal 100 in accordance with a state of the navigation apparatus 200. More specifically, when the navigation apparatus 200 is in the first reception state, in which the navigation apparatus 200 can receive the operation for enlarging or reducing the displayed map, for example, the navigation apparatus 200 transmits the first notification, which indicates that the navigation apparatus 200 is in the first reception state, to the wearable terminal 100. In addition, when stopping to receive the operation for enlarging or reducing the map, the navigation apparatus 200 transmits the second notification, which indicates that the first reception state has ended, to the wearable terminal 100. The navigation apparatus 200 also transmits the third notification, which indicates that the navigation apparatus 200 is not in the first reception state but in the second reception state, in which the navigation apparatus 200 receives the operations performed by the user 10 other than the operation for enlarging or reducing the map, to the wearable terminal 100.

The display unit 204 is a display screen on which images of a map and the like are displayed. The control unit 203 controls the images displayed on the display unit 204. The display unit 204 displays, on the screen, for example, a map indicating the surroundings of the current position of the navigation apparatus 200 and the current position of the vehicle 20 on the map. If the display unit 204 receives a touch operation performed by the user 10 on the screen when the map is displayed, the display unit 204 scrolls the displayed map such that a position on the map at which the touch operation has been performed comes to the center of the screen.

The map information storage unit 205 is a storage device used for storing map information. The map information stored in the map information storage unit 205 may be stored in advance before shipping from a factory or may be obtained from the map server 300 as a map including the current position.

The sound output unit 206 sends notifications to the user 10 by outputting a sound. The sound output unit 206 outputs a sound on the basis of control performed by the control unit 203. The sound output unit 206 is realized by a speaker.

The operation of the navigation system 1 configured as above will be described in detail hereinafter.

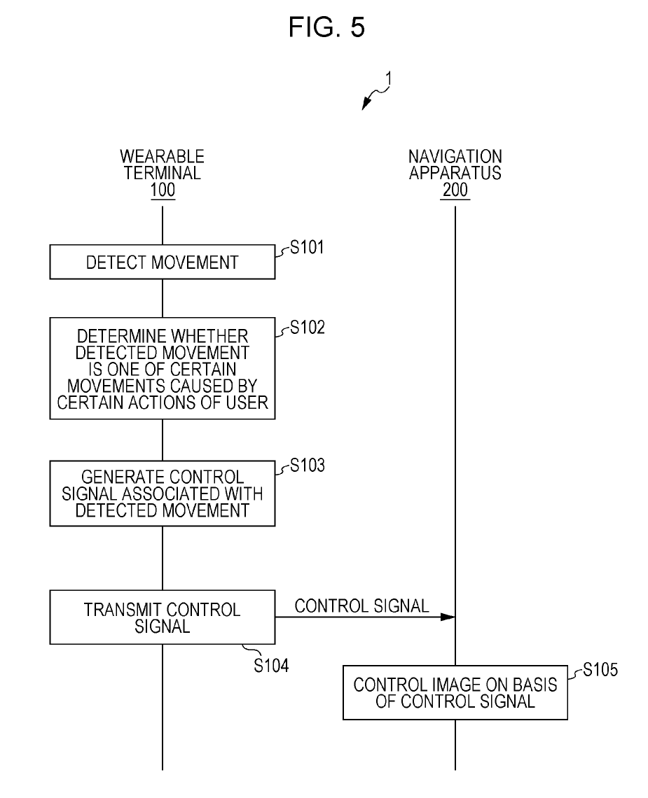

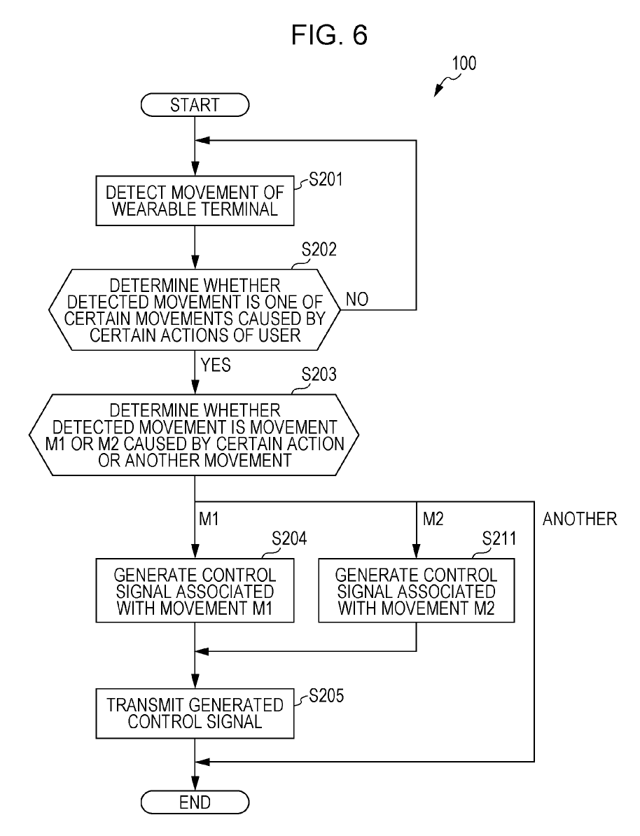

FIG. 5 is a sequence diagram illustrating a procedure of a process performed by the navigation system 1 according to the present embodiment. A process performed by the wearable terminal 100 will be described in detail later with reference to FIG. 6.

In step S101, the wearable terminal 100 detects a movement thereof. More specifically, the wearable terminal 100 detects changes in the position and attitude thereof as a movement using the detection unit 101.

In step S102, the wearable terminal 100 determines whether the movement thereof detected in step S101 is one of the certain movements caused by the certain actions of the user 10. More specifically, the wearable terminal 100 makes the determination using the determination unit 102.

In step S103, the wearable terminal 100 generates a control signal associated with the movement thereof detected in step S101 on the basis of a result of the determination made in step S102.

In step S104, the wearable terminal 100 transmits the control signal generated in step S103 to the navigation apparatus 200.

In step S105, the navigation apparatus 200 receives the control signal transmitted from the wearable terminal 100 in step S104 and controls an image displayed on the display unit 204 on the basis of the received control signal.

FIG. 6 is a flowchart illustrating a procedure of the process performed by the wearable terminal 100 according to the present embodiment.

In step S201, the detection unit 101 detects a movement (changes in position and attitude) of the wearable terminal 100. Step S201 corresponds to step S101 illustrated in FIG. 5.

In step S202, the determination unit 102 determines whether the movement of the wearable terminal 100 detected in step S201 is one of the certain movements caused by the certain actions of the user 10. Step S202 corresponds to step S102 illustrated in FIG. 5. If the determination unit 102 determines that the movement is one of the certain movements caused by the certain actions of the user 10 (YES in step S202), the process proceeds to step S203. On the other hand, if the determination unit 102 determines that the movement is not one of the certain movements caused by the certain actions of the user 10 (NO in step S202), the process returns to step S201.

In step S203, the determination unit 102 determines whether the movement detected in step S201 is a certain movement M1 or M2 caused by a certain action of the user 10, or another movement. A certain movement herein refers to a movement whose changes in position and attitude are predetermined, such as a rotational movement or a parallel translation. Although a case in which the certain movements are the actions M1 and M2 will be described hereinafter as an example, the same holds when there are three or more certain movements.

If it is determined in step S203 that the movement detected in step S101 is the movement M1 (M1 in step S203), the process proceeds to step S204, and if it is determined in step S203 that the movement detected in step S101 is the movement M2 (M2 in step S203), the process proceeds to step S211. If the movement detected in step S101 is another movement (ANOTHER in step S203), the process illustrated in FIG. 6 ends.

In step S204, the signal generation unit 103 generates a control signal for causing navigation apparatus 200 to enlarge the map displayed on the navigation apparatus 200, for example, as a control signal associated with the movement M1. Association between the movement and the control signal will be described later.

In step S211, the signal generation unit 103 generates a control signal for causing navigation apparatus 200 to reduce the map displayed on the navigation apparatus 200, for example, as a control signal associated with the movement M2. The association between the movement and the control signal will be described later.

In step S205, the communication unit 104 transmits the control signal generated in step S204 or S211 to the navigation apparatus 200. After step S205, the process illustrated in FIG. 6 ends.

The processing in each step will be described in more detail hereinafter. First, the processing performed after the detection unit 101 detects the movement of the wearable terminal 100 will be described in detail.

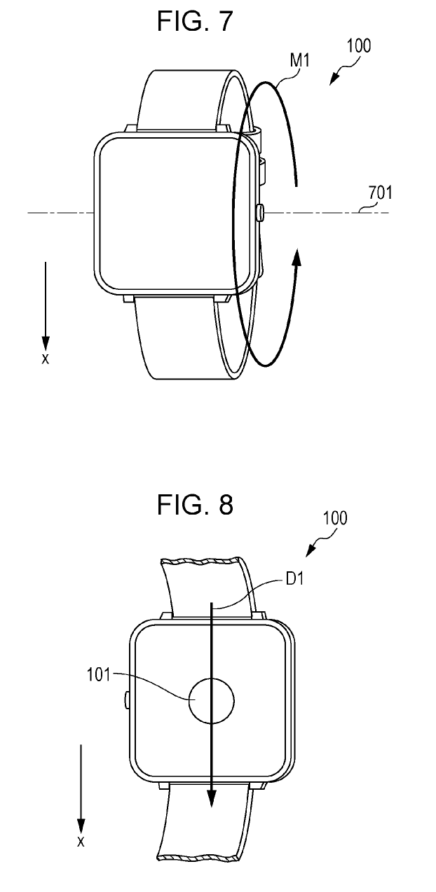

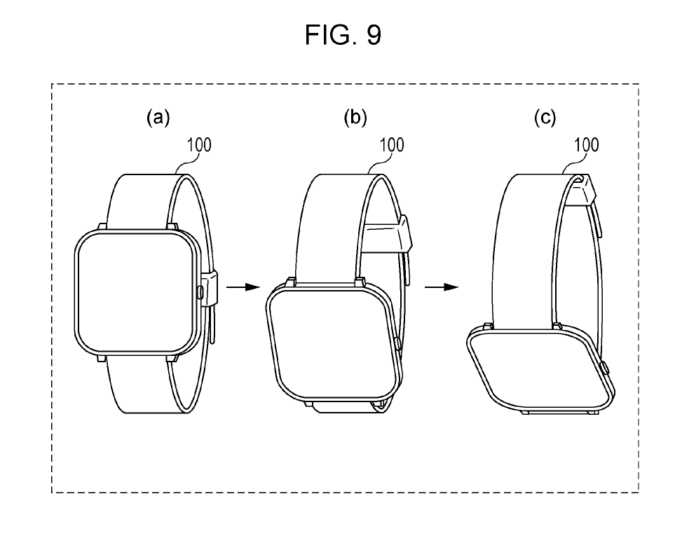

FIG. 7 is a schematic diagram illustrating a first movement of the wearable terminal 100 according to the present embodiment. FIG. 8 is a schematic diagram illustrating a direction detected by the detection unit 101 during the first movement of the wearable terminal 100 according to the present embodiment. FIG. 9 is a schematic diagram illustrating details of the first movement of the wearable terminal 100 according to the present embodiment. The first movement described hereinafter is an example of a certain movement caused by the user 10 who is twisting the arm on which the wearable terminal 100 is worn. The first movement will also be referred to as the “movement M1”.

The movement M1 illustrated in FIG. 7 is a rotational movement around a rotation axis 701. If the user 10 wears the wearable terminal 100, the rotation axis 701 is parallel to the arm of the user 10 on which the wearable terminal 100 is worn.

During the movement M1, the detection unit 101 detects that the position thereof changes in a direction (direction D1) parallel to an x-axis (FIG. 8) and that the attitude of the body 111 changes as the wearable terminal 100 rotates around the rotation axis 701 (FIG. 9).

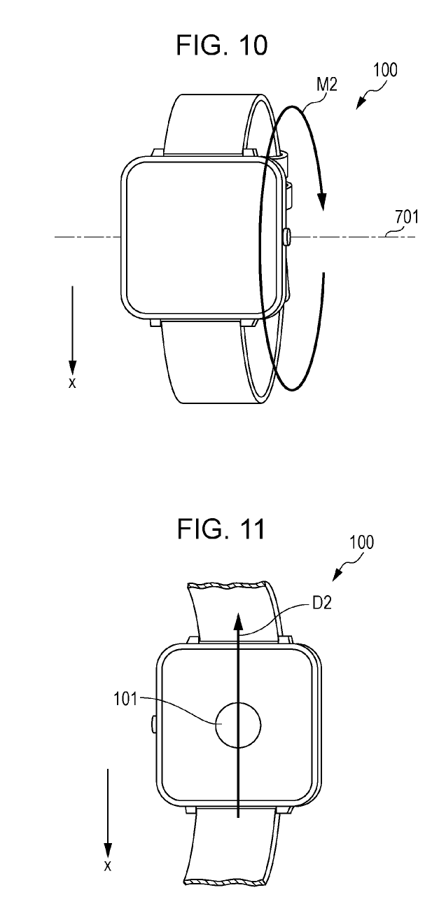

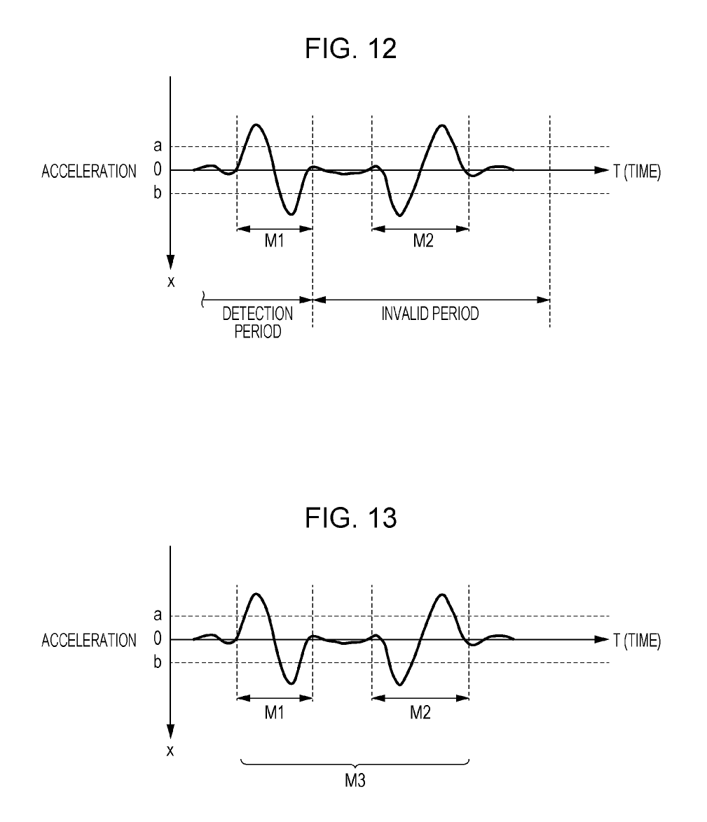

FIG. 10 is a schematic diagram illustrating a second movement of the wearable terminal 100 according to the present embodiment. FIG. 11 is a schematic diagram illustrating a direction detected by the detection unit 101 during the second movement of the wearable terminal 100 according to the present embodiment. The second movement will also be referred to as the “movement M2”.

The movement M2 illustrated in FIG. 10 is a rotational movement around the rotation axis 701 in a direction opposite to the direction in which the movement M1 occurs.

During the movement M2, the detection unit 101 detects that the position thereof changes in a direction (direction D2) opposite to the direction D1 (FIG. 11) and that the attitude of the body 111 changes as the wearable terminal 100 rotates around the rotation axis 701.

If the detection unit 101 detects the above changes in position and attitude (step S201), the determination unit 102 determines that the detected changes are caused by the movement M1 or M2 (step S203). The signal generation unit 103 generates the control signal associated with the movement M1 or M2 (step S204).

Next, a determination process performed by the determination unit 102 will be described in detail.

The determination unit 102 basically makes a determination as to a detected movement each time the detection unit 101 detects the movement of the wearable terminal 100. After twisting the arm, however, a person usually returns the arm to its original attitude (hereinafter also referred to as a “returning action”). If the user 10 twists the arm in order to operate the navigation apparatus 200, therefore, the wearable terminal 100 might determine that a returning motion after the twist is a new movement. In this case, the navigation apparatus 200 might be unintendedly operated. In order to avoid an unintended operation of the navigation apparatus 200 and enable the wearable terminal 100 to make determinations accurately, the following operation may be performed.

FIG. 12 is a schematic diagram illustrating acceleration detected by the detection unit 101 and a first example of a determination method used by the determination unit 102 according to the present embodiment.

The acceleration illustrated in FIG. 12 is acceleration detected by the detection unit 101 when the user 10 twists the arm and then returns the arm to its original attitude. The determination unit 102 determines whether the movement M1 or M2 has occurred on the basis of the acceleration detected by the detection unit 101. More specifically, if the detected acceleration falls below a negative threshold a along the x-axis and then exceeds a positive threshold b, the determination unit 102 determines that the wearable terminal 100 has made a movement M1. On the other hand, if the detected acceleration exceeds the threshold b and then falls below the threshold a, the determination unit 102 determines that the wearable terminal 100 has made a movement M2.

In this case, the determination unit 102 undesirably determines on the basis of the changes in acceleration illustrated in FIG. 12 that the wearable terminal 100 has made a movement M1 and then made a movement M2. The control signal associated with the movement M1 and the control signal associated with the movement M2 are sequentially transmitted to the navigation apparatus 200 (step S205).

In order to avoid this, the determination unit 102 may avoid making a movement determination for a certain period of time after a determination that the movement M1 or M2 has occurred. More specifically, even if the detection unit 101 detects a new movement of the wearable terminal 100 in the certain period of time after a determination that a movement detected by the detection unit 101 is one of the certain movements, the determination unit 102 may avoid determining whether the new movement is one of the certain movements. In doing so, the determination unit 102 can avoid determining a returning motion as a new movement. The certain period of time will also be referred to as an “invalid period”, and a period in which the determination unit 102 makes a movement determination will be referred to as a “detection period”.

The invalid period may last several seconds, that is, more specifically, three or five seconds. If the invalid period is too long, a new movement intended by the user 10 is not detected for a long time, which is undesirable. The determination unit 102 may analyze a history of the user's actions and set an appropriate length of the invalid period. The invalid period having an appropriate length is as short as possible but long enough to include a possible returning motion.

FIG. 13 is a schematic diagram illustrating an example of the acceleration detected by the detection unit 101 and a second example of the determination method used by the determination unit 102 according to the present embodiment.

The acceleration illustrated in FIG. 13 is the same as that illustrated in FIG. 12.

In order to avoid determining that the wearable terminal 100 has made movements M1 and M2, the determination unit 102 may determine a combination of the movements M1 and M2 in this order as a new movement M3. In this case, the determination unit 102 determines a combination of the movements M2 and M1 in this order as a new movement M4. The movements M3 and M4 are used in steps S203 and S204 instead of the movements M1 and M2, respectively. That is, (i) if the determination unit 102 determines that a movement detected by the detection unit 101 is the movement M3, the signal generation unit 103 generates a control signal for causing the navigation apparatus 200 to enlarge the map, and (ii) if the determination unit 102 determines that a movement detected by the detection unit 101 is the movement M4, the signal generation unit 103 may generate a control signal for causing the navigation apparatus 200 to reduce the map. In doing so, the determination unit 102 can avoid determining a returning motion as a new movement. The movement M3 of the wearable terminal 100 will also be referred to as a “third movement”, and the movement M4 of the wearable terminal 100 will also be referred to as a “fourth movement”.

The determination unit 102 may determine a combination of movements M1 and M2 as the new movement M3 only if the movement M2 is detected within a certain period of time after the movement M1 is detected. The certain period of time is desirably shorter than the invalid period, namely 0.5 or 1 second. In doing so, if the movement M2 does not occur within the certain period of time after the movement M1 occurs, another type of control can be performed. In another example of control, information (e.g., current time) may be displayed on the display unit 105 of the wearable terminal 100, or a backlight may be turned on. Since the wearable terminal 100 is a wristwatch terminal, for example, the user 10 might look at the wristwatch as an ordinary operation for checking the time. In addition, therefore, to the control performed on the navigation apparatus 200 through the certain movements described in the present embodiment, the wearable terminal 100 needs to enable the user 10 to check the time without performing any type of control on the navigation apparatus 200. In general, when the user 10 checks the time with the wearable terminal 100, the movement M1 illustrated in FIG. 7 occurs, and the wearable terminal 100 remains stationary for 0.5 or 1 second. By making the determination unit 102 determine a combination of movements M1 and M2 as the new movement M3 only if the movement M2 occurs within the certain period of time after the movement M1 is detected as described above, an operation for checking the time and operations for controlling the navigation apparatus 200 can be distinguished from each other.

The certain movements may be changes in position and attitude of the wearable terminal 100 caused at an acceleration equal to or higher than a threshold. In this case, the wearable terminal 100 can, using the acceleration of movements, clearly distinguish operations for controlling the navigation apparatus 200 from other operations performed by the user 10 during driving.

Movements of the wearable terminal 100 detected by the detection unit 101 may be as follows.

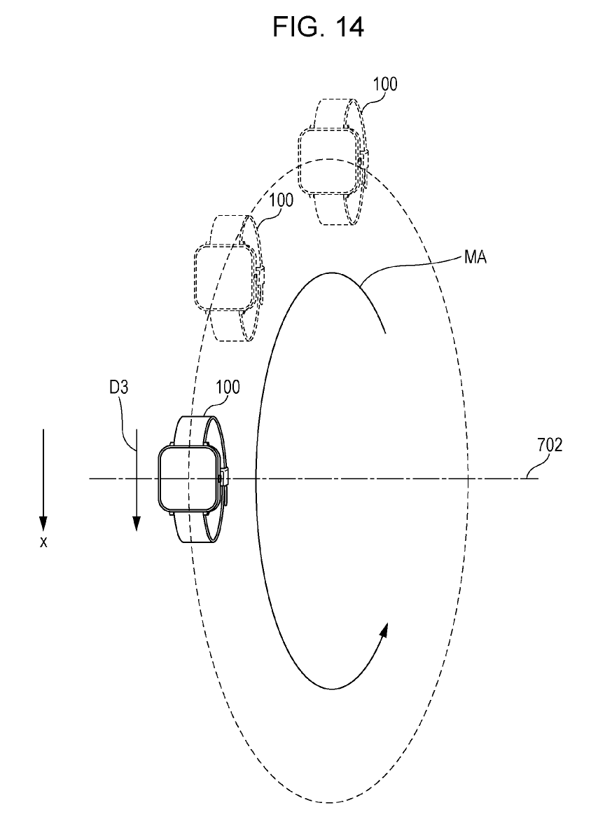

FIG. 14 is a schematic diagram illustrating a first modification of the first movement of the wearable terminal 100 according to the present embodiment.

A movement MA illustrated in FIG. 14 is a rotational movement of the wearable terminal 100 around a rotation axis 702. More specifically, the movement MA illustrated in FIG. 14 is an orbital movement around the rotation axis 702. If the wearable terminal 100 is worn by the user 10, the rotation axis 702 is parallel to the arm of the user 10 on which the wearable terminal 100 is worn.

During the movement MA, the detection unit 101 detects that the position thereof changes in a direction (direction D3) parallel to the x-axis but the attitude of the body 111 remains the same. A direction in which the position of the detection unit 101 changes constantly changes along an orbit of the detection unit 101 around the rotation axis 702.

The determination unit 102 may make a determination on the basis of the movement MA instead of the movement M1 illustrated in FIG. 7 and other figures. In this case, the determination unit 102 also makes a determination using an orbital movement whose direction is different from that of the movement MA instead of the movement M2.

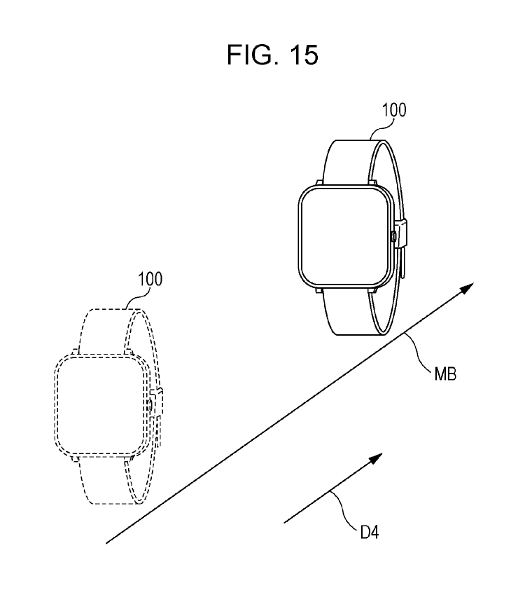

FIG. 15 is a schematic diagram illustrating a second modification of the first movement of the wearable terminal 100 according to the present embodiment.

The movement MB illustrated in FIG. 15 is a parallel translation in a direction D4. The direction of the parallel translation need not be relative to the arm of the user. The direction of the parallel translation may be a forward direction or a leftward direction of the user 10. Alternatively, the direction of the parallel translation may be a direction defined by the wearable terminal 100, that is, for example, a direction of 12 o'clock, if the display unit 105 indicates time with hands. In this case, the user 10 can intuitively understand which direction he/she needs to move the arm.

During the movement MB, the detection unit 101 detects that the position thereof changes in the direction D4 but the attitude of the body 111 remains the same.

The determination unit 102 may make a determination on the basis of the movement MB instead of the movement M1 illustrated in FIG. 7 and other figures. In this case, the determination unit 102 also makes a determination on the basis of a parallel translation whose direction is opposite to that of the movement MB instead of the movement M2.

The first movement may be a movement different from that described above. For example, if a movement in a certain direction whose speed or acceleration equal to or higher than a certain threshold is detected, the determination unit 102 may determine the movement as the first movement. Although determination methods based on acceleration have been described for the first movement with reference to FIGS. 12 and 13, a parameter other than acceleration may be used for the determination. Angle, for example, may be used. If an angle of the display unit 105 relative to a horizontal surface changes in a certain way, the determination unit 102 may determine the movement as the first movement. The horizontal surface refers, for example, to the ground, a floor of the vehicle 20, or the like. If, for example, the angle of the display unit 105 relative to the horizontal surface changes from a first angle (e.g., 90°) indicated by (a) in FIG. 9 to a second angle (e.g., 45°) indicated by (c) in FIG. 9 as the user 10 twists the arm and the display unit 105 (or the body 111) rotates downward as indicated by (b) in FIG. 9, the determination unit 102 may determine the movement as the first movement. In this case, too, the returning motion described above may be taken into consideration. That is, if the angle of the display unit 105 relative to the horizontal surface changes from the first angle (e.g., 90°) indicated by (a) in FIG. 9 to the second angle (e.g., 45°) indicated by (c) in FIG. 9 and returns to the first angle within a certain period of time, the determination unit 102 may determine the movement as the first movement. Although an example in which the first and second angles are 90° and 45°, respectively, has been described with reference to FIG. 9, the first and second angles are not limited to this example. The first and second angles may be any angles insofar as the first and second angles are different from each other.

An angular velocity (gyro) sensor may be adopted as the detection unit 101 in order to calculate the above angles.

Next, a process for generating a control signal performed by the signal generation unit 103 will be described.

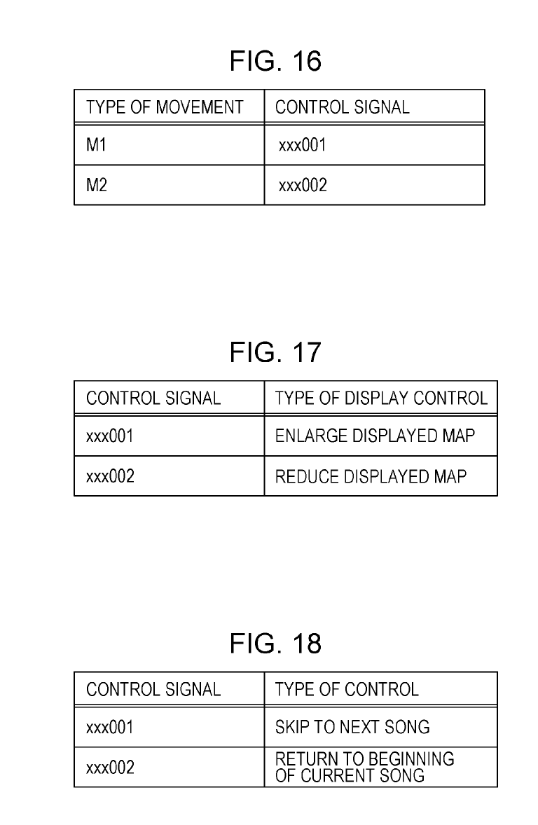

FIG. 16 is a diagram illustrating control signals generated by the signal generation unit 103 according to the present embodiment. More specifically, FIG. 16 illustrates a generation table used for the process for generating a control signal performed by the signal generation unit 103.

In the generation table illustrated in FIG. 16, types of movement and the control signals are associated with each other.

The types of movement indicate movements identified by the determination unit 102. The types of movement include, for example, the movement M1 and the movement M2.

The control signals indicate control signals generated by the signal generation unit 103 in accordance with the types of movement. If a movement detected by the detection unit 101 is determined by the determination unit 102 as the movement M1, for example, the signal generation unit 103 generates a control signal “xxx001”. If a movement detected by the detection unit 101 is determined by the determination unit 102 as the movement M2, for example, the signal generation unit 103 generates a control signal “xxx002”.

The generation table illustrated in FIG. 16 is stored in the signal generation unit 103. The signal generation unit 103 refers to the generation table and generates a control signal associated with an identified movement each time the determination unit 102 determines a movement detected by the detection unit 101 as a certain movement.

Next, a display control process performed by the navigation apparatus 200 on the basis of a control signal will be described.

FIG. 17 is a diagram illustrating types of display control performed by the navigation apparatus 200 according to the present embodiment. More specifically, FIG. 17 illustrates a control table used for the display control process performed by the navigation apparatus 200.

In the control table illustrated in FIG. 17, control signals and the types of display control are associated with each other.

The control signals indicate control information transmitted to the navigation apparatus 200 from the wearable terminal 100. The control signals correspond to those stored in the generation table (FIG. 16).

The types of display control indicate types of display control performed by the navigation apparatus 200 in accordance with the control signals. More specifically, if the navigation apparatus 200 receives the control signal “xxx001”, for example, the navigation apparatus 200 enlarges the map displayed thereon. In this case, the control signal “xxx001” is a control signal for causing the navigation apparatus 200 to enlarge the displayed map. Similarly, the control signal “xxx002” is a control signal for causing the navigation apparatus 200 to reduce the displayed map.

After receiving a control signal from the communication unit 104 of the wearable terminal 100, the navigation apparatus 200 refers to the control table and determines a type of control performed on the map displayed on the display unit 204.

The control process performed by the navigation apparatus 200 on the basis of control signals is not limited to enlargement and reduction of the map. Other examples of the control process performed by the navigation apparatus 200 on the basis of control signals will be described hereinafter.

FIG. 18 is a diagram illustrating types of control performed by the navigation apparatus 200 according to the present embodiment. More specifically, FIG. 18 is a control table used for the control process performed by the navigation apparatus 200.

In the control table illustrated in FIG. 18, control signals and the types of control are associated with each other.

The control signals are the same as those illustrated in FIG. 17.

The types of control indicate types of control performed by the navigation apparatus 200 in accordance with the control signals. If the navigation apparatus 200 has a function of playing back music and receives the control signal “xxx001”, for example, the navigation apparatus 200 skips to a next song.

On the other hand, if the navigation apparatus 200 receives the control signal “xxx002”, the navigation apparatus 200 returns to a beginning of a current song.

After receiving a control signal from the communication unit 104 of the wearable terminal 100, the navigation apparatus 200 refers to the control table and, for example, skips to the next song or returns to the beginning of the current song.

In this case, the control signal “xxx001” is a control signal for causing the navigation apparatus 200 to skip to the next song. Similarly, the control signal “xxx002” is a control signal for causing the navigation apparatus 200 to return to the beginning of the current song.

Next, the map displayed on the display unit 204 of the navigation apparatus 200 will be described in detail.

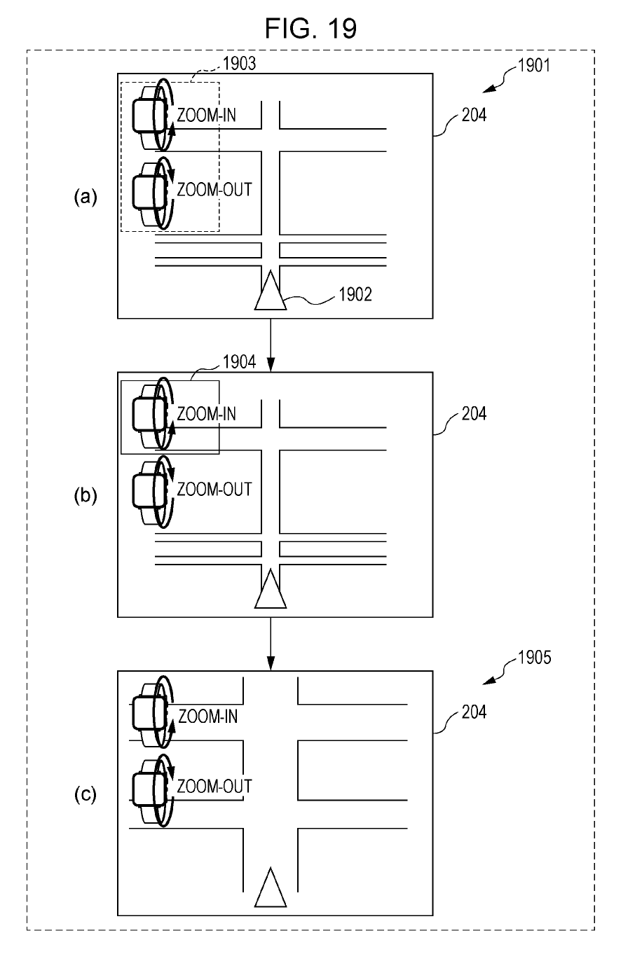

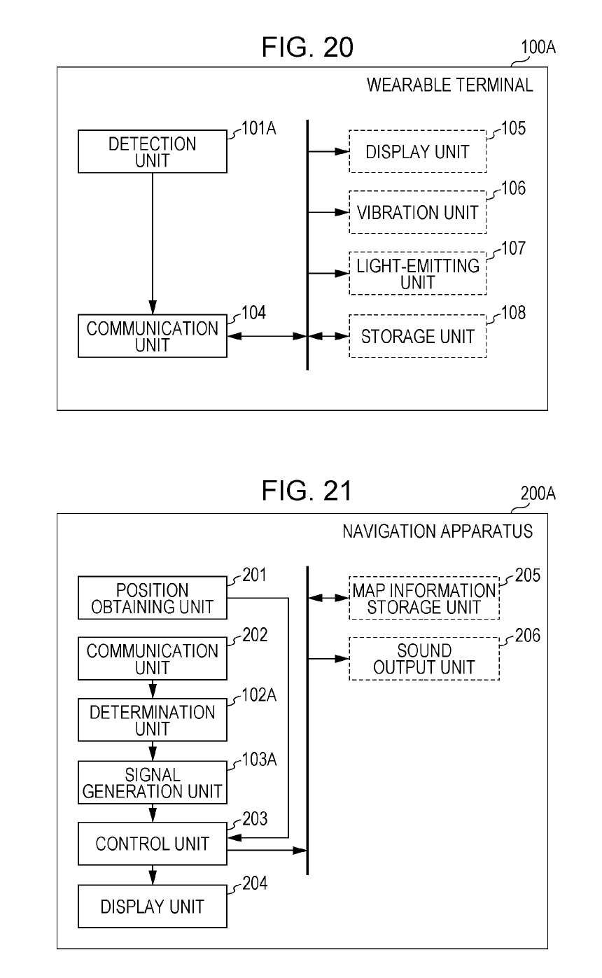

FIG. 19 is a diagram illustrating the display unit 204 of the navigation apparatus 200. More specifically, FIG. 19 illustrates a procedure in which the user 10 enlarges the map displayed on the navigation apparatus 200 using the wearable terminal 100.

In FIG. 19(a), the display unit 204 displays a map 1901 including the current position of the vehicle 20, a symbol 1902 (a solid triangle) indicating the current position of the vehicle 20 in the map 1901, and an operation guidance image 1903 (corresponds to the first guidance image), which is an image for notifying the user 10 of operations that can be performed.

The operation guidance image 1903 includes images indicating the appearance of the wearable terminal 100, arrows indicating directions in which the wearable terminal 100 needs to be rotated in order to control the navigation apparatus 200, and letters indicating how the map changes as a result of the operations. More specifically, the letters include “zoom-in” for enlarging the map and “zoom-out” for reducing the map.

If the user 10 rotates the wearable terminal 100 to zoom in the map, the navigation apparatus 200 displays an image illustrated in FIG. 19(b) on the display unit 204 and then displays an image illustrated in FIG. 19(c).

In FIG. 19(b), the display unit 204 emphasizes a part of the operation guidance image 1903 that indicates a zoom-in operation. The display unit 204 emphasizes the part by displaying a frame 1904 around the part. Alternatively, the display unit 204 may emphasizes the part by, for example, changing a color of the part, displaying the letters in boldface, increasing the size of the letters, or deleting the other letters. By emphasizing the part, the user 10 can understand that an operation corresponding to the action that he/she has taken is about to be performed on the navigation apparatus 200.

In FIG. 19(c), the display unit 204 displays a zoomed-in map 1905.

The user 10 can thus enlarge the map displayed on the navigation apparatus 200.

As described above, according to the wearable terminal 100 according to the present embodiment, if a certain movement of the wearable terminal 100 is detected, content displayed on the navigation apparatus 200 is controlled. That is, the user 10 can control the content displayed on the navigation apparatus 200 through a simple operation for which the user 10 need not move eyes or to which the user 10 need not pay attention, such as a twist of the arm. The user 10 therefore need not look at or pay attention to an input portion of the screen of the navigation apparatus 200. Since the user 10 can easily reduce or enlarge the map information that can be operated during driving using the wearable terminal 100 according to the present embodiment of the present disclosure, the content displayed on the navigation apparatus 200 can be controlled more safely. The wearable terminal 100 can thus help the user 10 control the navigation apparatus 200 without looking at the display screen.

### Second Embodiment

In a second embodiment, a wearable terminal according to another embodiment that helps the user 10 control a navigation apparatus without looking at a display screen will be described.

Function blocks of a navigation system 1A according to the present embodiment, an appearance of a wearable terminal 100A worn by the user 10, and a mode in which the wearable terminal 100A is used are the same as those illustrated in FIGS. 1A, 1B, and 1C, respectively, and detailed description thereof is omitted.

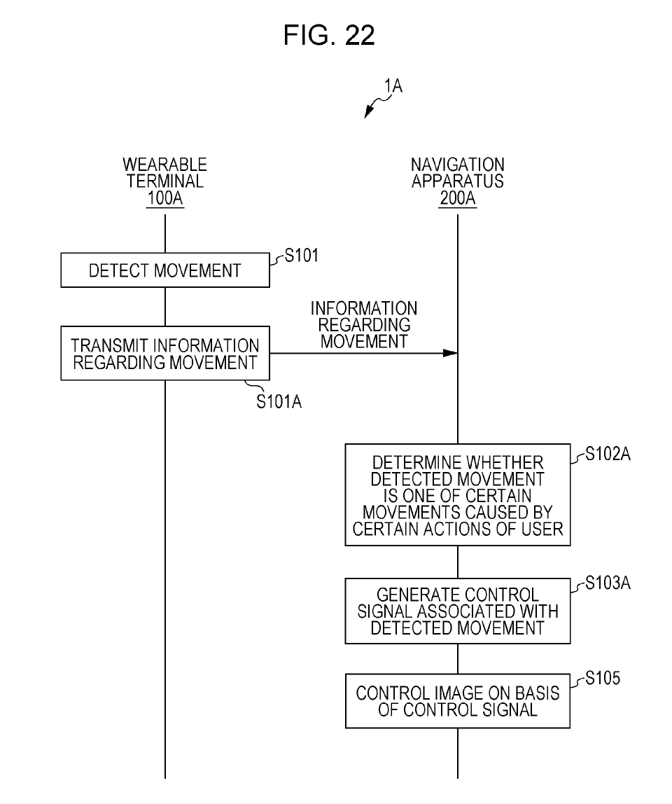

FIG. 20 is a block diagram illustrating function blocks of the wearable terminal 100A according to the present embodiment.

As illustrated in FIG. 20, the wearable terminal 100A includes a detection unit 101A and the communication unit 104. The wearable terminal 100A may further include the display unit 105, the vibration unit 106, the light-emitting unit 107, and the storage unit 108.

The wearable terminal 100A is different from the wearable terminal 100 according to the first embodiment in that the wearable terminal 100A includes the detection unit 101A instead of the detection unit 101 and does not include the determination unit 102 and the signal generation unit 103. The detection unit 101A will be described hereinafter. The other components are the same as those according to the first embodiment, and detailed description thereof is omitted.

The detection unit 101A detects a movement of the wearable terminal 100A using an acceleration sensor and detects changes in position and attitude of the wearable terminal 100A, that is, more specifically, the amount of change in position and attitude of the wearable terminal 100A, on the basis of the detected movement. The detection unit 101A transmits information indicating the detected movement to the navigation apparatus 200A through the communication unit 104. In other respects, the detection unit 101A is the same as the detection unit 101.

FIG. 21 is a block diagram illustrating function blocks of the navigation apparatus 200A according to the present embodiment.

As illustrated in FIG. 21, the navigation apparatus 200A includes the position obtaining unit 201, the communication unit 202, a determination unit 102A, a signal generation unit 103A, the control unit 203, and the display unit 204. The navigation apparatus 200A may further include the map information storage unit 205 and the sound output unit 206.

The navigation apparatus 200A is different from the navigation apparatus 200 according to the first embodiment in that the navigation apparatus 200A includes the determination unit 102A and the signal generation unit 103A. The other components are the same as those according to the first embodiment, and detailed description thereof is omitted.

The determination unit 102A is a processing unit that determines whether a movement detected by the detection unit 101A of the wearable terminal 100A is one of certain movements caused by certain actions of the user 10. The determination unit 102A is different from the determination unit 102 in that the determination unit 102A obtains information regarding a movement detected by the detection unit 101A of the wearable terminal 100A through the communication unit 104 and the communication unit 202. In other respects, the determination unit 102A is the same as the determination unit 102.

The signal generation unit 103A is a processing unit that generates a control signal for controlling the navigation apparatus 200A. The signal generation unit 103A is different from the signal generation unit 103 in that the signal generation unit 103A directly transmits a generated control signal to the control unit 203 without using a communication unit. In other respects, the signal generation unit 103A is the same as the signal generation unit 103.

FIG. 22 is a sequence diagram illustrating a procedure of a process performed by the navigation system 1A according to the present embodiment. The same steps as those in the sequence diagram according to the first embodiment (FIG. 5) are given the same reference numerals, and detailed description thereof is omitted.

In step S101, the wearable terminal 100A detects a movement thereof.

In step S101A, the wearable terminal 100A transmits information regarding the movement thereof detected in step S101 to the navigation apparatus 200A. More specifically, the wearable terminal 100A transmits the information regarding the movement thereof detected by the detection unit 101A to the navigation apparatus 200A through the communication unit 104. The transmitted information regarding the movement of the wearable terminal 100A is received by the navigation apparatus 200A.

In step S102A, the navigation apparatus 200A determines whether the movement of the wearable terminal 100A is one of the certain movements caused by the certain actions of the user 10 on the basis of the information regarding the movement of the wearable terminal 100A transmitted in step S101A. The determination process is the same as in step S102 according to the first embodiment, and description thereof is omitted.

In step S103A, the wearable terminal 100A generates a control signal associated with the movement of the wearable terminal 100A detected in step S101 on the basis of a result of the determination made in step S102A.

In step S105, the navigation apparatus 200A controls an image displayed on the display unit 204 on the basis of the control signal generated in step S103A.

As a result of the above process, the wearable terminal 100A can help the user 10 control the navigation apparatus 200A without looking at the display screen.

As described above, according to the wearable terminal 100A according to the present embodiment, the same advantageous effects as those of the wearable terminal 100 according to the first embodiment can be produced.

### Modification of Embodiments

A modification of the above embodiments will be described hereinafter.

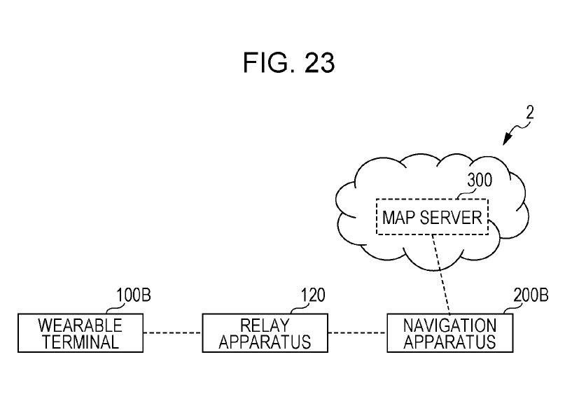

FIG. 23 is a block diagram illustrating function blocks of a navigation system 2 according to the modification of the above embodiments.

As illustrated in FIG. 23, the navigation system 2 includes a wearable terminal 100B, a relay apparatus 120, and a navigation apparatus 200B.

It is assumed here that the wearable terminal 100B and the navigation apparatus 200B are in a situation in which it is difficult for the wearable terminal 100B and the navigation apparatus 200B to communicate with each other directly. Such a situation may be, for example, a case in which the wearable terminal 100B and the navigation apparatus 200B do not include communication interfaces according to a common communication standard, a case in which the wearable terminal 100B and the navigation apparatus 200B are not permitted to communicate with each other directly for security purposes, or the like.

The relay apparatus 120 is a communication relay apparatus including a communication interface capable of communicating with the wearable terminal 100B and a communication interface capable of communicating with the navigation apparatus 200B. The relay apparatus 120 realizes communication between the wearable terminal 100B and the navigation apparatus 200B by transmitting a communication packet received using either of the two communication interfaces, that is, by forwarding the received communication packet. During the forwarding, information included in the communication packet may be changed as necessary.

More specifically, the wearable terminal 100B and the relay apparatus 120 may communicate with each other in accordance with a Bluetooth (registered trademark), and the relay apparatus 120 and the navigation apparatus 200B may communicate with each other in accordance with an IEEE 802.11 standard.

A process performed by the wearable terminal 100B and the navigation apparatus 200B is the same as that according to the above embodiments, and description thereof is omitted.

The wearable terminal 100B and the navigation apparatus 200B can thus indirectly communicate with each other through the relay apparatus 120, even if the wearable terminal 100B and the navigation apparatus 200B are in a situation in which it is difficult for the wearable terminal 100B and the navigation apparatus 200B to communicate with each other directly.

In the above embodiments, each of the components may be realized by a dedicated piece of hardware, or may be realized by executing a suitable software program. Alternatively, a program execution unit such as a central processing unit (CPU) or a processor may realize each of the components by reading and executing a software program recorded on a recording medium such as a hard disk or a semiconductor memory. Software that realizes the wearable terminal and the like according to each of the above embodiments is the following program.

That is, the program causes a computer to implement a method for controlling a wearable terminal to be worn on an arm of a person. The method includes detecting a movement of the wearable terminal, determining whether the movement detected in the detecting is a one of certain movements caused by certain actions of the person, generating, if it is determined in the determining that the movement detected in the detecting is one of the certain movements, a control signal for causing a navigation apparatus to change, in accordance with the detected certain movement, a map displayed on the navigation apparatus that is installed in a vehicle and that is capable of communicating with the wearable terminal, and transmitting the control signal generated in the generating to the navigation apparatus.

Although a wearable terminal according to one or a plurality of aspects has been described above on the basis of embodiments, the present disclosure is not limited to these embodiments. The one or the plurality of aspects may include embodiments obtained by modifying the above embodiments in various ways that can be conceived by those skilled in the art and embodiments obtained by combining components in different embodiments with one another, insofar as the scope of the present disclosure is not deviated from.

The present disclosure can be applied to a wearable terminal that helps a user control a navigation apparatus without looking at a display screen. More specifically, the present disclosure can be applied to a wristwatch terminal, a wristband terminal, and other wearable terminals.

What is claimed is:

1. A wearable terminal to be worn on an arm of a person, the wearable terminal comprising:
a detector that detects a movement of the wearable terminal;
a determiner that determines whether the movement detected by the detector is a one of certain movements caused by certain actions of the person;
a generator that, if the determiner determines that the movement detected by the detector is one of the certain movements, generates a control signal for causing a navigation apparatus to change, in accordance with the detected certain movement, a map displayed on the navigation apparatus, the navigation apparatus being installed in a vehicle and being capable of communicating with the wearable terminal; and
a communicator that transmits the control signal generated by the generator to the navigation apparatus.

2. The wearable terminal according to claim 1,
wherein the certain movements are rotational movements of the wearable terminal caused by certain actions of the person.

3. The wearable terminal according to claim 2,
wherein the wearable terminal has a ring shape when wound around the arm of the person, and
wherein the certain movements are rotational movements around the arm in a circumferential direction of the wearable terminal caused when the person twists the arm on which the wearable terminal is worn.

4. The wearable terminal according to claim 2,
wherein the control signal is a control signal for causing the navigation apparatus to enlarge or reduce the map in accordance with the detected certain movement.

5. The wearable terminal according to claim 4,
wherein the determiner determines whether the movement detected by the detector is (a) a first movement, which is one of the certain movements and a first rotational movement, or (b) a second movement, which is one of the certain movements and a second rotational movement in a direction opposite to the direction of the first rotational movement, and
wherein, (i) if the determiner determines that the movement detected by the detector is the first movement, the generator generates the control signal for causing the navigation apparatus to enlarge the map, and (ii) if the determiner determines that the movement detected by the detector is the second movement, the generator generates the control signal for causing the navigation apparatus to reduce the map.

6. The wearable terminal according to claim 1,
wherein, even if the detector detects a new movement of the wearable terminal within a certain period of time after the determiner determines the movement detected by the detector is one of the certain movements, the determiner does not determine whether the new movement is one of the certain movements.

7. The wearable terminal according to claim 4,
wherein the determiner determines whether the movement detected by the detector is (a) a third movement, which is one of the certain movements caused when a rotational movement occurs in a first direction and then another rotational movement occurs in a second direction, which is opposite to the first direction, or (b) a fourth movement, which is one of the certain movements caused when a rotational movement occurs in the second direction and then another rotational movement occurs in the first direction, and
wherein, (i) if the determiner determines that the movement detected by the detector is the third movement, the generator generates the control signal for causing the navigation apparatus to enlarge the map, and (ii) if the determiner determines that the movement detected by the detector is the fourth movement, the generator generates the control signal for causing the navigation apparatus to reduce the map.

8. The wearable terminal according to claim 1,
wherein the certain movements are changes in a position and an attitude of the wearable terminal caused at an acceleration equal to or higher than a threshold.

9. The wearable terminal according to claim 1, further comprising:
a display that, if the determiner determines that the movement detected by the detector is one of the certain movements, displays an image indicating occurrence of the detected certain movement.

10. The wearable terminal according to claim 1, further comprising:
a vibrator that vibrates if the determiner determines that the movement detected by the detector is one of the certain movements.

11. The wearable terminal according to claim 1, further comprising:
a light emitter that emits light if the determiner determines that the movement detected by the detector is one of the certain movements.

12. The wearable terminal according to claim 1,
wherein, if the determiner determines that the movement detected by the detector is one of the certain movements, the generator generates a control signal for causing the navigation apparatus to display an image indicating occurrence of the detected certain movement on a display screen of the navigation apparatus, and
wherein the communicator transmits the control signal generated by the generator to the navigation apparatus.

13. The wearable terminal according to claim 1,
wherein, if the determiner determines that the movement detected by the detector is one of the certain movements, the generator generates a control signal for causing the navigation apparatus to output a sound indicating occurrence of the detected certain movement, and
wherein the communicator transmits the control signal generated by the generator to the navigation apparatus.

14. The wearable terminal according to claim 1,
wherein the communicator is capable of communicating with the navigation apparatus through wireless communication of a connection type according to a certain wireless communication standard,
wherein, if the navigation apparatus is located in a range in which the communicator is capable of communicating with the navigation apparatus, the communicator automatically, or in accordance with an instruction from the person, establishes a wireless communication connection with the navigation apparatus, and
wherein the determiner makes a determination only when the connection is established.

15. The wearable terminal according to claim 14,
wherein the determiner makes a determination when the communicator has established the connection and received, from the navigation apparatus, a first notification, which indicates that the navigation apparatus is in a first reception state, in which the navigation apparatus is capable of receiving an operation for enlarging or reducing the map.

16. The wearable terminal according to claim 14,
wherein the determiner does not make a determination when the communicator has established the connection and received, from the navigation apparatus, a second notification, which indicates that the navigation apparatus has stopped receiving an operation for enlarging or reducing the map.

17. The wearable terminal according to claim 15,
wherein, when the navigation apparatus is in the first reception state, the generator generates a control signal for displaying, on a display screen of the navigation apparatus, a first guidance image for notifying the person of the operation for enlarging or reducing the map, and
wherein the communicator transmits the control signal generated by the generator to the navigation apparatus.

18. The wearable terminal according to claim 17,
wherein the first guidance image includes an image indicating a mode of a rotational movement of the wearable terminal and an image indicating how the map changes as a result of the rotational movement of the wearable terminal.

19. The wearable terminal according to claim 15,
wherein the determiner makes a determination when the communicator has received, from the navigation apparatus, a third notification, which indicates that the navigation apparatus is not in the first reception state but in a second reception state, in which the wearable terminal receives operations performed by the person other than the operation for enlarging or reducing the map.

20. The wearable terminal according to claim 19,
wherein the operations performed by the person other than the operation for enlarging or reducing the map include (i) an operation for displaying a display area that is currently not displayed on the map, (ii) an operation for switching information superimposed upon the map, and (iii) an operation for turning to a next page or turning back to a previous page of information that is different from the map and that includes a plurality of pages.

21. The wearable terminal according to claim 19,
wherein, when the navigation apparatus is in the second reception state, the generator generates a control signal for causing the navigation apparatus to display, on a display screen of the navigation apparatus, a second guidance image for notifying the person of operations performed on the navigation apparatus other than the operation for enlarging or reducing the map, and
wherein the communicator transmits the control signal generated by the generator to the navigation apparatus.

22. The wearable terminal according to claim 21,
wherein the second guidance image includes an image indicating a mode of a rotational movement of the wearable terminal and an image indicating a result of an operation performed as a result of the rotational movement of the wearable terminal.

23. The wearable terminal according to claim 1,
wherein the vehicle is an automobile,
wherein the communicator receives control information regarding control of the automobile through the navigation apparatus,
wherein the control information regarding the control of the automobile includes information indicating whether an acceleration operation or a braking operation has been performed in the automobile, and
wherein, only if the control information received by the communicator indicates that either the acceleration operation or the braking operation has been performed, (i) the determiner makes a determination or (ii) the communicator transmits a control signal.

24. The wearable terminal according to claim 1,
wherein the vehicle is an automobile,
wherein the communicator receives control information regarding control of the automobile through the navigation apparatus,
wherein the control information regarding the control of the automobile includes information indicating whether a steering wheel of the automobile has been operated, and
wherein, if the control information received by the communicator indicates that the steering wheel has been operated, (i) the determiner is inhibited from making a determination or (ii) the communicator is inhibited from transmitting a control signal.

25. The wearable terminal according to claim 14,
wherein the certain wireless communication standard is Bluetooth (registered trademark) or Institute of Electrical and Electronics Engineers 802.11.

26. The wearable terminal according to claim 1,
wherein at least any of the determiner, the generator, and the communicator includes a processor.

27. A method for controlling a wearable terminal to be worn on an arm of a person, the method comprising:
detecting a movement of the wearable terminal;
determining whether the movement detected in the detecting is a one of certain movements caused by certain actions of the person;
generating, if it is determined in the determining that the movement detected in the detecting is one of the certain movements, a control signal for causing a navigation apparatus to change, in accordance with the detected certain movement, a map displayed on the navigation apparatus, the navigation apparatus being installed in a vehicle and being capable of communicating with the wearable terminal; and
transmitting the control signal generated in the generating to the navigation apparatus.

28. The method according to claim 27,
wherein at least any of the determining, the generating, and the transmitting is performed by a processor.
